(19) United States
(12) Patent Application Publication
(10) Pub. No.: US 2021/0125439 A1
(43) Pub. Date: Apr. 29, 2021

(54) WATCH WITH THE FUNCTION OF AUTOMOBILE KEY

(71) Applicant: Shenzhen Mujing Intelligent Technology Co., Ltd., Shenzhen (CN)

(72) Inventors: Bihui TU, Quanzhou (CN); Junjie ZHANG, Shenzhen (CN)

(21) Appl. No.: 16/666,439

(22) Filed: Oct. 29, 2019

(51) Int. Cl. G07C 9/00; G04G 99/00; G04G 17/08; G04G 17/02

(52) U.S. Cl. CPC G07C 9/00896; G04G 99/006; A44C 5/0007; G04G 17/02; G04G 17/08

(57) ABSTRACT

The patent relates to the technical field of smart wearable device, and discloses a watch with the function of automobile key, including: watch case, which is hollow inside and open at both ends, the watch case is made of metal material, the watch case is provided with a rubber cover, one end of the rubber cover is provided with a holding groove, the holding groove is provided with a watch movement, the first power supply for providing electric energy to the watch is provided in the watch movement, and one end of the watch movement that is far away from the rubber cover is provided with a dial, dial is provided with hands, the rubber cover is provided with a automobile key module, the automobile key module is provided with a locking button for closing the door lock and a unlocking button for opening the door lock, and one end of the automobile key module is provided with a second power supply for providing power to the automobile key module. The watch is powered by the first power supply, the automobile key module is powered by the second power supply, and the door lock can be opened by unlocking button and the door lock can be closed by locking button, so as to realize the operation of dual independent batteries, so that the watch does not need to be recharged, can be used for a long time, and is convenient for energy saving.

### TECHNICAL FIELD

The patent relates to the technical field of smart wearable device, in particular to a watch with the function of automobile key.

### BACKGROUND TECHNOLOGY

In existing technology, the watch with the function of automobile key generally has the phenomenon of complex structure, various accessories and difficult production. The combination structure of the watch movement and the automobile key module is relatively complex, and they share the same battery source, which will increase the power consumption of battery and affect the overall service life. In addition, the structure of the high-frequency signal contact case is too simple and does not have the anti-seismic function. In the actual wearing, the signal transmission will be interrupted.

Therefore, how to improve the performance of the automobile key watch becomes an urgent technical problem.

### CONTENT OF PATENT

The technical problem to be solved by the patent is to improve the operation performance of the automobile key watch.

For this reason, according to the first aspect, the patent discloses a watch with the function of automobile key, which includes a watch case, the watch case is hollow inside and has openings at both ends, the watch case is made of metal material, the watch case is provided with a rubber cover, one end of the rubber cover is provided with a holding groove, the holding groove is provided with a watch movement, and the watch movement is provided with a first power supply used to power a watch, one end of the watch movement far away from the rubber cover is provided with a dial for displaying the time scale, the dial is provided with hands for indicating the time scale, the hands are rotationally connected with the watch movement, one end of the case is provided with a bezel clamped with the watch case, the bezel is internally clamped with a first glass, and the rubber cover is internally provided with a automobile key module used to control the working state of the automobile door lock, the automobile key module is provided with a locking button for closing the door lock and a unlocking button for opening the door lock, the automobile key module is provided with a second power supply for providing electric energy to the automobile key module, and the end of the rubber cover far away from the watch case is provided with a case back for fastening the rubber cover, the case back is clamped with a second glass.

The patent is further arranged that the automobile key module is electrically connected with a high-frequency signal contactor for transmitting high-frequency signals, and the high-frequency signal contactor collides with the case.

The patent is further arranged that the high frequency signal contactor comprises a contactor body fixedly connected with the automobile key module, the contactor body is provided with a spring, one end of the contactor body is embedded with a contact column, one end of the contact column is butted with the watch case, and the other end is fixedly connected with the spring.

The patent is further arranged that the contact column is T-shaped.

The patent is further arranged that the automobile key module is provided with a low-frequency emission source on the same side of the second power supply, and the low-frequency emission source is used for transmitting low-frequency signals.

The patent is further arranged that one end of the rubber cover is symmetrically provided with a hook for clamping and fixing the automobile key module.

The patent is further arranged that one end of the rubber cover is provided with a positioning column, and the automobile key module is provided with a positioning hole which is inserted and matched with the positioning column.

The patent is further arranged that the positioning hole is arranged in a circular shape.

The patent has the following beneficial effects: the watch is powered by the first power supply, the automobile key module is powered by the second power supply, and the door lock is opened by the unlocking button and the door lock is closed by the locking button to realize the double independent battery operation, so that the watch does not need to be recharged, can be used for a long time, is convenient for energy saving, and improves the operation performance of the automobile key watch.

### DESCRIPTION OF DRAWINGS

In order to more clearly explain the specific implementation mode or technical solutions in existing technology of the patent, the following will make a brief introduction to the drawings needed in the specific implementation mode or existing technology description. Obviously, the drawings in the following description are some examples of the patent. For ordinary technicians in the field, they do not pay creative labor, other drawings can also be obtained according to these drawings.

FIG. 1 is a diagram of an explosive structure of a watch with automobile key function disclosed in this example.

FIG. 2 is the structure diagram of the rubber cover of a watch with automobile key function disclosed in this example.

FIG. 3 is the structure diagram of the automobile key module of a watch with automobile key function disclosed in this example.

FIG. 4 is the structure diagram of the automobile key module of a watch with automobile key function disclosed in this example.

FIG. 5 is a connection structure diagram of the watch movement, the rubber cover and the automobile key module in the watch with automobile key function disclosed in this example.

FIG. 6 is a structure diagram of a high frequency signal contactor of a watch with automobile key function disclosed in this example.

FIG. 7 is a high frequency signal transmission diagram of a watch with automobile key function disclosed in this example.

FIG. 8 is a low frequency signal transmission diagram of a watch with automobile key function disclosed in this example.

Reference mark: 1, Watch case. 2, Rubber cover. 21, Holding groove. 22, Hook. 23, Positioning column. 3, Watch movement. 31, First power supply. 4, Dial. 5, Hands. 6, Bezel. 7, First glass. 8, Automobile key module. 81, Locking button. 82, Unlocking button. 83, Second power supply. 84, Positioning hole. 9, Case back. 10, Second glass. 11, High frequency signal contactor. 111, Contactor body. 112, Spring. 113, Contact column. 12, Low frequency emission source.

### SPECIFIC IMPLEMENTATION MODE

In order to make the purpose, technical scheme and advantages of the patent clearer, the patent will be further described in detail in combination with the attached drawings and examples. It should be understood that the specific examples described herein are only used to explain the patent and are not used to limit the patent.

In the description of the patent, it should be noted that unless specified and defined, the terms “installation” and “connection” should be understood in a broad sense, for example, it can be fixed connection, detachable connection or integrated connection, mechanical connection, electrical connection, direct connection or indirect connection through intermediate media. The connection can also be the internal connection of two components, wireless connection or wired connection. For normal technician in this field, the specific meaning of the above terms in the patent can be understood in specific situations.

In the description of the patent, it should be noted that the direction or position relationship of the terms “center”, “top”, “bottom”, “left”, “right”, “vertical”, “horizontal”, “inside”, “outside” and other indications is based on the direction or position relationship shown in the drawings, only for the convenience of describing the patent and simplifying the description, rather than indicating or implying the device or element indicated must have a specific orientation, be constructed and operated in a specific orientation, so it cannot be understood as a limitation of this patent. In addition, the terms “first”, “second” and “third” are used for descriptive purposes only and cannot be understood as indicating or implying relative importance.

In addition, the technical features in the different implementation mode of the present patent described below can be combined with each other as long as they do not constitute a conflict with each other.

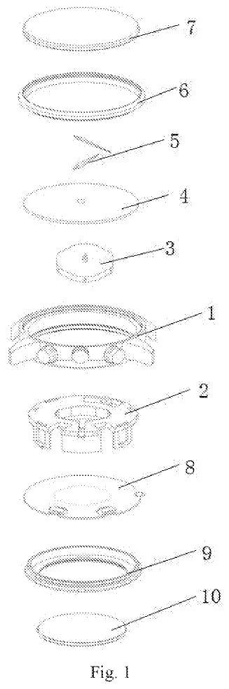

The patent discloses a watch with the function of automobile key, as shown in FIG. 1-5, including: the watch case 1, which is hollow inside and has openings at both ends, the watch case 1 is made of metal material, the watch case 1 is provided with a rubber cover 2, one end of the rubber cover 2 is provided with a holding groove 21, the holding groove 21 is provided with a watch movement 3, the watch movement 3 is provided with a first power supply 31 inside for supplying electric energy to the watch, and one end of the watch movement 3 which is far away from the rubber cover 2 is provided with a dial 4 for displaying the time scale, the dial 4 is provided with hands 5 for indicating the time scale, and the hands 5 is rotationally connected with the watch movement 3, and one end of the case 1 is provided with a bezel 6 which is clamped with a first glass 7, the rubber cover 2 is provided with a automobile key module 8 for controlling the working state of the door lock, the automobile key module 8 is provided with a locking button 81 for closing the door lock and a unlocking button 82 for opening the door lock, one end of the automobile key module 8 close to the rubber cover 2 is provided with a second power supply 83 for providing electric energy to the automobile key module 8, the end of the rubber cover 2 far away from the watch case 1 is provided with a case back 9 for tightening the rubber cover 2, and the case back 9 is clamped with a second glass 10. In the specific implementation process, the case 1 can be externally connected with a watch strap for easy wearing. The outer wall of the case 1 is provided with a locking button 81 for closing the door lock and a unlocking button 82 for opening the door lock. The automobile key module 8 only consume power when the locking button 81 and the unlocking button 82 are pressed, and does not consume any power in normal wearing.

It should be noted that the watch is powered by the first power supply 31, the automobile key module 8 is powered by the second power supply 83, and the door lock is opened by the unlocking button 82, and the door lock is closed by the locking button 81, realizing the operation of dual independent batteries, so that the watch does not need to be recharged, can be used for a long time, is convenient for energy saving, and improves the operation performance of the automobile key watch.

As shown in FIG. 1, the automobile key module 8 is connected with a high frequency signal contactor 11 for transmitting high frequency signals, and the high frequency signal contactor 11 collides with the case 1.

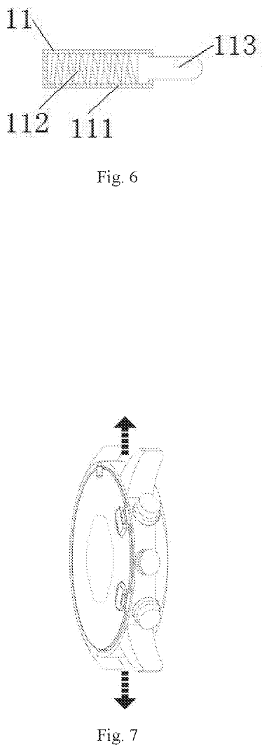

As shown in FIG. 1 and FIG. 6, the high frequency signal contactor 11 includes a contactor body 111 fixedly connected with the automobile key module 8, a spring 112 is arranged in the contactor body 111, a contact column 113 is embedded in one end of the contactor body 111, one end of the contact column 113 is butted with the case 1, and the other end is fixedly connected with the spring 112. In the specific implementation process, one end of the contact column 113 is butted with the case 1, and the high frequency signal is transmitted through the case 1.

As shown in FIG. 6, the contact column 113 is T-shaped.

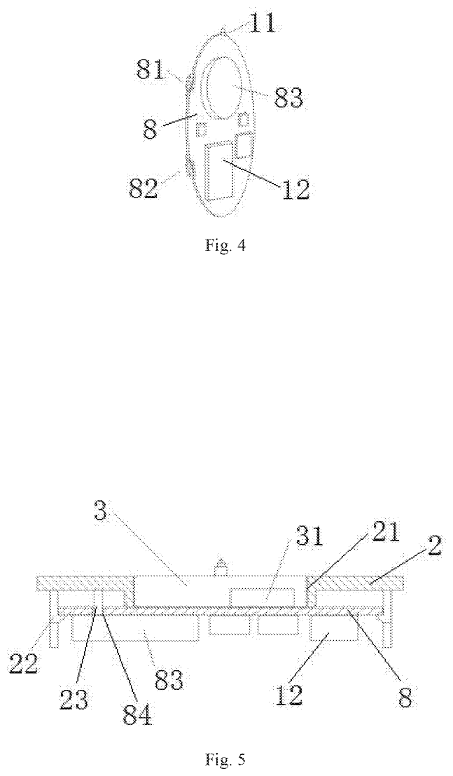

As shown in FIG. 1 and FIG. 4, the automobile key module 8 is provided with a low-frequency emission source 12 located on the same side of the second power supply 83, and the low-frequency emission source 12 is used for transmitting low-frequency signals. In the specific implementation process, the dial 4 can be made of metal materials, making the dial 4 more diverse.

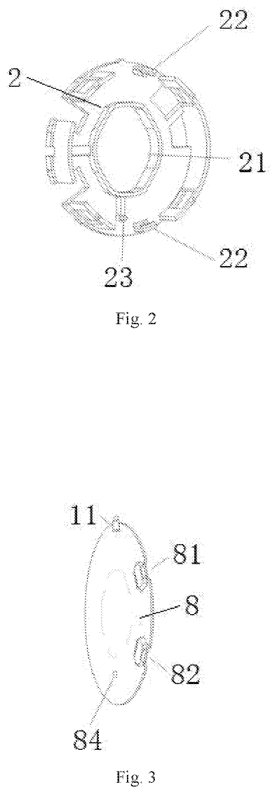

As shown in FIG. 1, FIG. 2 and FIG. 5, one end of the rubber cover 2 is symmetrically provided with a hook 22 for clamping and fixing the automobile key module 8.

As shown in FIG. 1, FIG. 2 and FIG. 5, one end of the rubber cover 2 is provided with a positioning column 23, and the automobile key module 8 is provided with a positioning hole 84 which is inserted and matched with the positioning column 23.

It should be noted that the automobile key module 8 is stably fixed in the case 1 through the fixing function of the hook 22 and the plug-in cooperation of the positioning column 23 and the positioning hole 84, which can effectively prevent vibration.

As shown in FIG. 3, the positioning hole 84 is arranged in a circular shape.

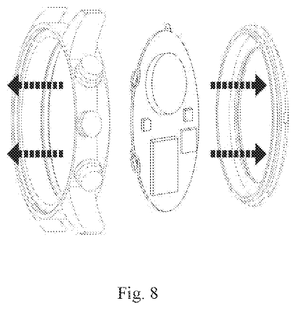

As shown in FIG. 7 and FIG. 8, FIG. 7 is a diagram of high frequency signal transmission of a watch with automobile key function disclosed in this example, FIG. 8 is a diagram of low frequency signal transmission of a watch with automobile key function disclosed in this example. The automobile key module 8 realizes the opening and closing of the door lock through the transmission of high frequency signal and low frequency signal.

Working principle: the watch is powered by the first power supply 31, the automobile key module 8 is powered by the second power supply 83, the high-frequency signal is transmitted by the high-frequency signal contactor 11 and the low-frequency signal is transmitted by the low-frequency transmission source 12, and the door lock is opened by the unlocking button 82 and the door lock is closed by the locking button 81, realizing the operation of dual independent batteries, so that the watch does not need to be recharged, and can be long time use, convenient energy saving, improve the operation performance of the automobile key watch.

Obviously, the above examples are only for the purpose of clear explanation, rather than limiting the implementation mode. For normal technician in this field, other changes in different forms may be made on the basis of the above description. There is no need and no way to exhaust all the ways of implementation. And the obvious changes caused thereby are still within the scope of protection of this patent.

1. A watch with automobile key function, which is characterized in that: including watch case 1, the watch case 1 is hollow inside and has openings at both ends, the watch case 1 is made of metal material, the watch case 1 is provided with a rubber cover 2, one end of the rubber cover 2 is provided with a holding groove 21, the holding groove 21 is provided with a watch movement 3, the watch movement 3 is provided with a first power supply 31 inside for supplying electric energy to the watch, and one end of the watch movement 3 which is far away from the rubber cover 2 is provided with a dial 4 for displaying the time scale, the dial 4 is provided with hands 5 for indicating the time scale, and the hands 5 is rotationally connected with the watch movement 3, and one end of the case 1 is provided with a bezel 6 which is clamped with a first glass 7, the rubber cover 2 is provided with a automobile key module 8 for controlling the working state of the door lock, the automobile key module 8 is provided with a locking button 81 for closing the door lock and a unlocking button 82 for opening the door lock, one end of the automobile key module 8 close to the rubber cover 2 is provided with a second power supply 83 for providing electric energy to the automobile key module 8, the end of the rubber cover 2 far away from the watch case 1 is provided with a case back 9 for tightening the rubber cover 2, and the case back 9 is clamped with a second glass 10.

2. The watch with automobile key function according to claim 1, which is characterized in that the automobile key module 8 is electrically connected with a high frequency signal contactor 11 for transmitting high frequency signal, and the high frequency signal contactor 11 collides with the case 1.

3. The watch with automobile key function according to claim 2, which is characterized in that the high frequency signal contactor 11 comprises a contactor body (111) fixedly connected with the automobile key module 8, the contactor body 111 is provided with a spring 112, one end of the contactor body 111 is embedded with a contact column 113, and one end of the contact column 113 is butted with the case 1, the other end is fixedly connected with the spring 112.

4. The watch with automobile key function according to claim 3, which is characterized in that the contact column 113 is set in T shape.

5. The watch with automobile key function according to claim 1, which is characterized in that the automobile key module 8 is provided with a low-frequency emission source 12 on the same side of the second power supply 83, and the low-frequency emission source 12 is used for transmitting low-frequency signals.

6. The watch with automobile key function according to claim 1, which is characterized in that one end of the rubber cover 2 is symmetrically provided with a hook 22 for clamping and fixing the automobile key module 8.

7. The watch with automobile key function according to claim 1, which is characterized in that one end of the rubber cover 2 is provided with a positioning column 23, and the automobile key module 8 is provided with a positioning hole 84 which is inserted and matched with the positioning column 23.

8. The watch with automobile key function according to claim 7, which is characterized in that the positioning hole 84 is arranged in a circular shape.
